(19) United States
(12) Patent Application Publication
(10) Pub. No.: US 2002/0120043 A1
(43) Pub. Date: Aug. 29, 2002

(54) REDISPERSIBLE POWDERS BASED ON CARBOXYLATED BUTADIENE-CONTAINING COPOLYMERS

(76) Inventors: BERND ROTHENHAUSSER, HALLE (DE); VOLKER KIESEL, HALLE (DE); HARTMUT KUHN, HALLE (DE); DOMINIK ELSASSER, AU (CH)

Correspondence Address: HORST M KASPER, 13 FOREST DRIVE, WARREN, NJ, 07059

(21) Appl. No.: 09/155,306

(22) PCT Filed: Mar. 25, 1997
(86) PCT No.: PCT/DE97/00607

(30) Foreign Application Priority Data
Apr. 3, 1996 (DE) 19613302.5
Mar. 17, 1997 (DE) 19710380.4

(51) Int. Cl. C08J 3/00

(52) U.S. Cl. 524/158; 524/157; 524/160; 524/161; 524/162

(57) ABSTRACT

The invention concerns well dispersible powders on the basis of carboxylated copolymers containing butadiene made of styrene and/or acrylonitrile, whose films taken from redispersion show good tensile strength. According to the invention, the latices are sprayed with mixtures of spraying aids consisting of 1 to 15 weight % of a salt of the alkylated di-phenyl-ether-di-sulphonic acid, caseinate and/or N-alkyl sulphosuccinamide and/or with 1 to 20 weight % of a di- or tetra sodium or potassium salt of an addition product from N-alkyl sulphosuccinamates with maleic acid mixed together with polyvinyl alcohol. The dispersions can be used especially in the construction industry and they offer an alternative to copolymers on the basis of polyvinyl acetates and acrylates.

The invention concerns well redispersible powders on the basis of carboxylated copolymers containing butadiene which can be used especially well in the construction industry as a result of its properties of block consistency and tensile strength/elasticity level of the films taken from redispersion.

Dispersions on the basis of carboxylated butadiene/styrene-copolymers are being used increasingly in the construction industry. Because of their comparable properties, they offer an alternative to copolymers on the basis of polyvinyl acetates and acrylates, which are frequently offered in the form of powders. The three main components of these powders—polymer, spraying aids and anti-blocking agents—influence one another mutually, so that there are frequently interferences in the desired properties.

For instance, a polymer set for soft has a high tendency to block. Of course, the tendency to block may be corrected by means of an appropriate spraying aid with a significant share of anti-blocking agent. However, because of the spraying aid, this leads to the powder having a high water susceptibility. At the same time, it leads to a disturbance in the filming behaviour from the redispersion.

Furthermore, using too much anti-blocking agent displaces the original properties which were caused by the polymer and also disturbs filming from redispersion.

Therefore, each powder recipe is a compromise and has to be optimised with regard to each application.

The positive qualities of carboxylated copolymers containing butadiene are first of all the fact that it has high flexibility accompanied by good cohesion on polar substrates. Furthermore, it is easily possible to adjust its flexibility to the level adjusted to each area of application by changing the relationship between monomers which control “hard” and “soft”. Another important property of this material class is the possibility of crosslinking through heat or by using crosslinking agents, such as melamine urea formaldehyde resins.

For this application it is advantageous to use the powder form of the carboxylated dispersions containing butadiene.

It is well known that dispersions and redispersed dispersion powders are used in the construction industry and what effect they have [see the magazine TIZ 9, page 698 (1985)]. Dispersions such as these are generally used in hydraulically hardening systems such as repair mortar, floor levelling compound and tile cement to influence the cohesion to the substrate, the processing viscosity and the solidity of the hardened compound, as an example.

One of the most important properties of the carboxylated copolymers containing butadiene is the tensile strength/elasticity level of the films taken from the redispersion as well as the possibility of creating networks to increase the level of tensile strength. These properties are also characteristic for the behaviour of the mixtures which are used in the construction industry. Therefore, it is necessary that these properties are also retained in the powder form.

Producing redispersed films and powders on the basis of butadiene/styrene-copolymers has been known in principle. In order to keep the corresponding products, redispersed agents or spraying aids are used and the compound is dried either as a film or converted to powders in a suitable spray tower, if necessary by adding anti-blocking agents.

For instance, U.S. Pat. No. 3,968,063 describes the use of urea, glycerol and sugar as redispersing agents. An SBR latex is used as dispersion and then dried to a film after mixing it with the agents mentioned above. Afterwards, this film is redispersed with a high-speed mixer. U.S. Pat. No. 3,822,230 also describes the redispersibility of films from carboxylated styrene/butadiene-copolymers. Phthalic acid derivatives are used here as redispersing aids. There is no information given on the conversion to block-free free-flowing powders. EP 0 632 096 also specified with amino-functional polyvinyl alcohols and EP 0 477 900 specifies polyvinyl alcohol in a mixture with a completely saponified 1-alkyl vinylester/vinylester copolymer which shows a Hoppler viscosity of 1 to 5 mPAS, in connection with styrene/butadiene-copolymers as spraying aids.

U.S. Pat. No. 3,409,578 describes another direction. In this process, a hard shell is produced on a soft core by linking metallic ions such as calcium, barium or zinc through carboxyl groups which could originate from the basic polymer or an additional polymer on the surface.

U.S. Pat. No. 3,784,648 or DE-AS 2 049 114 mention the production of free-flowing and lump-free powders on the basis of butadiene/styrene-copolymers. The condensation product containing “sulphonate groups” and composed of melamine and formaldehyde is used as a spraying aid.

A copolymer dispersion with a polymer basis consisting of 40 weight % butadiene and 60 weight % styrene was sprayed using this spraying aid. Received was a free-flowing redispersed powder. However, according to DE 2 049 114, showed an average particle size between 2,000 and 7,000 nm. These figures are significantly higher than in the initial dispersions, which generally lie between 100 and 200 nm with this type of dispersion. This means that there is not sufficient redispersion and forming the film from redispersion has therefore been obstructed. There are no statements to be found in patent specifications about the properties of films taken from redispersions.

The invention had the task of producing redispersible powders on the basis of copolymers containing butadiene which can be well redispersed, show sufficient block consistency and whose films taken from redispersion show a level of tensile strength/elasticity values which approach that of the initial dispersion. Furthermore, the crosslinking capability, through heat and by means of crosslinking agents such as melamine urea formaldehyde resins, must remain intact.

The object of the invention are redispersible powders from dispersions on the basis of copolymers of butadiene with styrene and/or acrylonitrile which contain 0.5 to 15 weight % in reference to the polymers, preferably 1 to 8 weight % of a non-saturated carbonic acid with one or two carbonic acid groups such as acrylic acid. methacrylic acid, fumaric acid, maleic acid or itaconic acid, or mixtures of them. These dispersions are sprayed with 1 to 15 weight % of a salt of the alkylated diphenyl-ether-di-sulphonic acid, caseinate and/or N-alkyl sulphosuccinamide. preferably 2- 10 weight % or with 1 to 20 weight % of a di- or tetra-sodium or potassium salt of an addition product from N-alkyl sulphosuccinamates with maleic acid mixed together with polyvinyl alcohol. 2 to 10 weight % of tetra-sodium-N-(1.2 di-carboxyethyl)-N-oleyl sulphosuccinamates and 4 to 15 weight % of polyvinyl alcohol are preferably used.

Primarily used are 2 to 10 weight % tetra-sodium-N-(1,2-di-carboxylethyl)-N-oleyl sulphosuccinamate and 4 to 15 weight % polyvinyl alcohol.

an additional 2 to 30 weight % of anti-blocking agent such as chalk, talcum, diatomaceous earth, kaolin, silicates, silicic acid, cements, calcium carbonate and similar materials may be injected. The powder is then produced in the usual spraying, disk or drum dryers. The viscosity of the solutions to be sprayed should not exceed 2 Pa·s(see DE 34 17 388). If necessary, aids such as viscosity regulators foaming agents may be added. The drying temperatures for these systems are generally between 60° and 80° C.

The following examples serve the purpose of making further explanations on the invention and make the positive qualities of redispersible powders according to invention more clear showing the property figures achieved. Examples 1 through 3 comparable values and they therefore explain the latest developments in technology and are not according to invention. The dispersions listed in Table 1 are sprayed in a spraying drier adding 15 weight % of finely distributed aluminium silicate.

TABLE 1
The Composition of the Latices Used in the Examples

| Latex | % | % | % | % | |
|---|---|---|---|---|---|
| No. | Butadiene | Styrene | Acrylonitrile | Carbonic Acid | % |
| 1 | 77 | 23 | none | none | |
| 2 | 60 | 40 | none | none | |
| 3 | 50 | 49 | none | acrylic acid | 1 |
| 4 | 62 | 36 | none | acrylic acid | 2 |
| 5 | 30 | 68 | none | acrylic acid | 2 |
| 6 | 60 | 37 | none | acrylic acid | 3 |
| 7 | 60 | 36 | none | acrylic acid | 4 |
| 8 | 60 | 39 | none | itaconic acid | 1 |
| 9 | 30 | 68 | none | itaconic acid | 2 |
| 10 | 50 | 48 | none | itaconic acid | 2 |
| 11 | 60 | 37 | none | itaconic acid | 3 |
| 12 | 57 | none | 40 | methacrylic acid | 3 |
| 13 | 63 | none | 35 | methacrylic acid | 2 |
| 14 | 53 | 10 | 35 | methacrylic acid | 2 |

Each of the spraying agents are described in each of the examples and compiled in Table 2 for dispersions with alkylated diphenyl-ether-di-sulphonic acid salts, caseinate and/or N-alkyl sulphosuccinamide, and in Table 3 for dispersions with tetra-sodium-N-(1.2 di-carboxyethyl)-N-oleyl sulphosuccinamate and polyvinyl alcohol.

TABLE 2

| Example | N-F-K | D-Ä-S | Caseinate | A-S-S |
|---|---|---|---|---|
| (Series 1) | Weight % | Weight % | Weight % | Weight % |
| 1/1 | 10 | | | |
| 1/2 | 10 | | | |
| 1/3 | | | 10 | |
| 1/4 | | 4 | 10 | |
| 1/5 | | 2 | 10 | |
| 1/6 | | 6 | 10 | |
| 1/7 | | 10 | 10 | |
| 1/8 | | 6 | 4 | |
| 1/9 | | 2 | 10 | |
| 1/10 | | 6 | 15 | |
| 1/11 | 2 | 6 | 2 | |
| 1/12 | 1 | 6 | 1 | |
| 1/13 | | 6 | 2 | |
| 1/14 | | 10 | | 4 |
| 1/15 | | 2 | | 10 |
| 1/16 | | 4 | | 15 |
| 1/17 | | 6 | 5 | 5 |
| 1/18 | | 8 | 4 | |

N-F-K: naphthalene-sulphonic acid formaldehyde condensate
D-Ä-S 2 A1: di-phenyl-ether-di-sulphonic acid-Na
A-S-S: N-alkyl sulphosuccinamide

TABLE 3

| | | PVOH | PVOH | PVOH |
|---|---|---|---|---|
| Example | TNOS | 4-88 | 17-88 | 10-98 |
| (Series 2) | Weight % | Weight % | Weight % | Weight % |
| 2/1 | | 10 | | |
| 2/2 | | | | 10 |
| 2/3 | | 20 | | |
| 2/4 | 05 | 12 | | |
| 2/5 | 1 | | 12 | |
| 2/6 | 2 | | | 12 |
| 2/7 | 2 | 15 | | |
| 2/8 | 1 | 15 | | |
| 2/9 | 1 | | 10 | |
| 2/10 | 1 | | | 15 |
| 2/11 | 2 | | | 15 |
| 2/12 | 2 | 10 | | |
| 2/13 | 2 | | 10 | |
| 2/14 | 2 | | | 10 |
| 2/15 | 4 | 8 | | |
| 2/16 | 4 | | 8 | |
| 2/17 | 4 | | | 8 |
| 2/18 | 4 | | 6 | |

PVOH 4-88: polyvinyl alcohol 4-88:
PVOH 17-98: polyvinyl alcohol 17-98
PVOH 10-98: polyvinyl alcohol 10-98 (fully saponified)
TNOS: tetra-sodium-N-(1.2 di-carboxyethyl)-N-oleyl sulphosuccinamate

The blocking behaviour of the resulting powders was determined in the following fashion:

50 cm³ of powder is filled into a metal cylinder with an inner diameter of 60 mm and a height of 150 mm. Then, a stamp with a weight of 5,000 g is inserted and the sample is stored at 20° C. for 24 hours. Afterwards, the powder tablet is slowly pressed from the cylinder and assessed using the following scale:

| Mark | |
|---|---|
| 1 | no powder tablet |
| 2 | it is not possible to pick up the powder tablet with one's fingers |
| 3 | it is possible to pick up the powder tablet with one's fingers |
| 4 | the powder tablet falls apart with a small amount of finger pressure |
| 5 | the powder tablet falls apart into crumbs |
| 6 | the powder tablet remains solid |

The redispersibility of the powder is determined by means of a sedimentation analysis. 50 ml of a 5% redispersion is filled into a sedimentation buret with a 0.1 ml graduation. The amount of the bottom sediment is read after 24 hours. In accordance with this method, a redispersion which could be assessed as good may only show values between 2 and 10, which are caused by the anti-blocking agent.

Furthermore, a 50% redispersion is produced from the powder. The resulting particle size is determined from this using an ultra-fine particle analyser. The film/elasticity level of the films taken from the initial dispersion or, as the case may be, the unheated redispersion, the redispersion heated to 145° C. for 10 minutes as well as in the networked state is determined pursuant to DIN 53 504. Crosslinking is accomplished by adding 10 weight % (in relation to the polymer) of a melamine urea formaldehyde resin.

### EXAMPLE SERIES 1

### Example 1/1

Latex No. 1 from Table 1, with a styrene content of 23 weight %, is mixed with 10 weight % of naphthalene-sulphonic acid formaldehyde condensate and sprayed as illustrated in Table 2 in summarised fashion. The resulting powder was lumpy and sticky in the spray-drying apparatus. It was not possible to produce complete redispersion since the approximately 40 weight % of the powder was not redispersible. The films taken from the redispersion were cracked and of low solidity. The further results may be found in Table 4.

### Example 1/2

A latex with a styrene content of 40 weight % (latex 2 from Table 1) is sprayed with naphthalene-sulphonic acid formaldehyde condensate in accordance with Table 2. The resulting powder was lumpy and could only be poorly redispersed. In the block test a solid tablet was formed.

### Example 1/3

A latex from Example 2 is sprayed using caseinate (see Tables 1 and 2). This did improve the spraying behaviour. However, the powder showed very poor blocking behaviour. The redispersibility and the film values were also not satisfactory.

### Examples 1/4 to 1/8

We worked according to the invention, as complied in Tables 1 and 2. The resulting powders could be redispersed well and also showed good blocking resistance. The films taken from redispersion were to a certain extent even higher as far as their tensile strength/elasticity level was concerned as in examples 4, 7, 10, 14 and 16. The crosslinking behaviour was not impaired.

### EXAMPLE SERIES 2

### Example 2/1

Latex No. 1 from Table 1, with a styrene content of 23 weight %, is mixed with 10 weight % polyvinyl alcohol 4 -88 and sprayed as illustrated in Table 2 in summarised fashion. The first number specified in the type designation 4 -88 shows the viscosity of a 4% solution of polyvinyl alcohol measured in mPas while the second number gives the degree of hydrolysis of the polyvinyl alcohol. The resulting powder was lumpy and sticky in the spray-drying apparatus. It was not possible to produce complete redispersion since approximately 40 weight % of the powder was not redispersible. The films taken from the redispersion were cracked and of low solidity. The further results may be found in Table 5.

### Example 2/2

A latex with a styrene content of 40 weight % (latex 2 from Table 1) is sprayed with polyvinyl alcohol in accordance with Table 3. The resulting powder was lumpy and could only be poorly redispersed. In the block test a solid tablet was formed.

### Example 2/3

A latex from Example 2 is sprayed using an increased amount of polyvinyl alcohol (see Tables 1 and 3). This did improve the spraying behaviour. However, the powder showed very poor blocking behaviour. The redispersibility and the film values were also not satisfactory.

### Examples 2/4 to 2/18

We worked according to the invention, as complied in Tables 1 and 3. The powders which resulted could be redispersed well and also showed good blocking resistance. The films taken from redispersion were at the level of the initial dispersion, to a certain extent they were even higher, as in examples 4, 7, 10, 14 and 16. The crosslinking behaviour was not impaired.

TABLE 4
Analysis Data from Example Series 1

| | | Dispersion | Film | | | Powder | Redispersion | | | Film | | Film | | Film | |
|---|---|---|---|---|---|---|---|---|---|---|---|---|---|---|---|
| | | TG | TG | | | Block | TG | TG | Redisper- | Unheated | | Heated | | Crosslinked | |
| Example | Latex | (mn) | (mv) | F | D | Test | (mn) | (mv) | sibility | F | D | F | D | F | D |
| No | No | nm | nm | N/mm² | % | Mark | nm | nm | mm | N/mm² | % | N/mm² | % | N/mm² | % |
| 1 | 1 | 180 | 240 | 10 | 900 | 5 | 690 | 900 | | film | | | | | |
| | | | | | | | | | | cracked | | | | | |
| 2 | 2 | 120 | 160 | 8 | 450 | 5 | 350 | 800 | 20 | 2 | 100 | 1.5 | 110 | 2.5 | 100 |
| 3 | 2 | 120 | 160 | 8 | 450 | 5 | 250 | 400 | 15 | 4 | 120 | 4 | 100 | 4.5 | 110 |
| 4 | 3 | 130 | 150 | 4 | 700 | 1 | 150 | 180 | 2 | 5.2 | 680 | 8 | 500 | 10 | 300 |
| 5 | 4 | 124 | 131 | 9.2 | 450 | 1 | 135 | 179 | 2 | 8.5 | 420 | 11 | 400 | 14 | 350 |
| 6 | 5 | 153 | 159 | 2 | 750 | 1 to 2 | 175 | 190 | 1 | 2 | 700 | 2.5 | 700 | 3 | 650 |
| 7 | 6 | 111 | 127 | 7.5 | 500 | 1 | 178 | 181 | 4 | 8 | 490 | 9.5 | 400 | 11 | 350 |
| 8 | 7 | 108 | 116 | 8 | 480 | 1 | 125 | 174 | 6 | 7.1 | 480 | 7.9 | 450 | 9.3 | 410 |
| 9 | 8 | 119 | 133 | 7.8 | 510 | 1 | 121 | 141 | 5 | 7.5 | 490 | 8.3 | 480 | 10.7 | 460 |
| 10 | 9 | 125 | 147 | 1.5 | 800 | 1 | 135 | 182 | 8 | 1.5 | 800 | 1.8 | 800 | 3.7 | 850 |
| 11 | 10 | 123 | 151 | 5.6 | 730 | 1 | 138 | 192 | 3 | 6.2 | 700 | 6.7 | 660 | 9.1 | 500 |
| 12 | 11 | 148 | 166 | 8.1 | 370 | 1 to 2 | 159 | 192 | 4 | 8 | 350 | 9.2 | 600 | 9.5 | 550 |
| 13 | 12 | 142 | 173 | 2.1 | 800 | 1 | 168 | 199 | 2 | 1.9 | 790 | 3.5 | 750 | 4.5 | 700 |
| 14 | 6 | 111 | 127 | 7.5 | 500 | 1 | 138 | 167 | 1 | 9.1 | 480 | 7.5 | 450 | 8.3 | 440 |
| 15 | 6 | 111 | 127 | 7.5 | 500 | 1 to 2 | 149 | 187 | 5 | 7 | 490 | 7.9 | 460 | 8.6 | 450 |
| 16 | 6 | 111 | 127 | 7.5 | 500 | 1 | 178 | 195 | 4 | 8.3 | 490 | 7.7 | 400 | 8.5 | 380 |
| 17 | 13 | 130 | 150 | 6.5 | 450 | 1 | 152 | 199 | 4 | 6.4 | 420 | 7.8 | 400 | 10.2 | 350 |
| 18 | 14 | 105 | 122 | 9.8 | 200 | 1 | 125 | 160 | 5 | 9.5 | 180 | 9.9 | 150 | 10.7 | 140 |

TG: particle size
mn: distribution of numbers
mv: volume distribution
F: solidity
D: elongation

TABLE 5
Analysis Data from Example Series 2

| | | Dispersion | Film | | | Powder | Redispersion | | | Film | | Film | | Film | |
|---|---|---|---|---|---|---|---|---|---|---|---|---|---|---|---|
| | | TG | TG | | | Block | TG | TG | Redisper- | Unheated | | Heated | | Crosslinked | |
| Example | Latex | (mn) | (mv) | F | D | Test | (mn) | (mv) | sibility | F | D | F | D | F | D |
| No | No | nm | nm | N/mm² | % | Mark | nm | nm | mm | N/mm² | % | N/mm² | % | N/mm² | % |
| 1 | 1 | 180 | 240 | 10 | 900 | 5 | 800 | 950 | 25 | film | | | | | |
| | | | | | | | | | | cracked | | | | | |
| 2 | 2 | 120 | 160 | 8 | 450 | 5 | 300 | 810 | 30 | | | | | | |
| 3 | 2 | 120 | 160 | 8 | 450 | 4 | 410 | 780 | 16 | 2 | 300 | 4 | 250 | 4 | 200 |
| 4 | 3 | 130 | 150 | 4 | 700 | 1 | 140 | 160 | 2 | 5 | 650 | 7 | 600 | 10.2 | 400 |
| 5 | 4 | 124 | 131 | 9.2 | 450 | 1 to 2 | 130 | 150 | 1 | 9.5 | 460 | 10.4 | 450 | 12.1 | 400 |
| 6 | 5 | 153 | 159 | 2 | 750 | 1 | 165 | 170 | 2 | 1.9 | 740 | 3.2 | 700 | 5.1 | 550 |
| 7 | 6 | 111 | 127 | 7.5 | 500 | 1 | 120 | 140 | 4 | 9.1 | 480 | 10 | 500 | 14.2 | 480 |
| 8 | 7 | 108 | 116 | 8 | 480 | 1 | 110 | 140 | 2 | 7.9 | 480 | 8.5 | 480 | 9.8 | 410 |
| 9 | 8 | 119 | 133 | 7.8 | 510 | 1 | 130 | 170 | 1 | 8.1 | 530 | 8.3 | 510 | 9.7 | 420 |
| 10 | 9 | 125 | 147 | 1.5 | 800 | 1 to 2 | 145 | 180 | 1 | 1.2 | 780 | 1.4 | 720 | 2.8 | 510 |
| 11 | 10 | 123 | 151 | 5.6 | 730 | 1 to 2 | 130 | 157 | 0 | 6.6 | 700 | 7 | 650 | 9.1 | 540 |
| 12 | 11 | 148 | 166 | 8.1 | 370 | 1 to 2 | 160 | 185 | 4 | 8.2 | 320 | 8.5 | 250 | 9.7 | 210 |
| 13 | 12 | 142 | 173 | 2.1 | 800 | 1 | 180 | 188 | 2 | 2 | 800 | 2.1 | 720 | 3.4 | 680 |
| 14 | 6 | 111 | 127 | 7.5 | 500 | 1 | 130 | 147 | 3 | 7.8 | 450 | 8.2 | 410 | 9.9 | 370 |
| 15 | 6 | 111 | 127 | 7.5 | 500 | 1 | 135 | 158 | 1 | 7.1 | 460 | 8.4 | 430 | 9.9 | 390 |
| 16 | 6 | 111 | 127 | 7.5 | 500 | 1 to 2 | 135 | 159 | 1 | 6.3 | 420 | 7.1 | 410 | 8.2 | 360 |
| 17 | 13 | 130 | 150 | 6.5 | 450 | 1 | 140 | 163 | 1 | 6 | 410 | 6.8 | 410 | 8.1 | 360 |
| 18 | 14 | 105 | 122 | 9.8 | 200 | 1 | 110 | 125 | 2 | 9 | 200 | 9.1 | 180 | 10.2 | 150 |

TG: particle size
mn: distribution of numbers
mv: volume distribution
F: solidity
D: elongation

1. Redispersible powders based on carboxylated butadiene-containing copolymers of styrene and/or acrylonitrile, the film of which made by re-dispersion is of a high tensile strength, whereby the carboxylated styrene-butadiene-lattices with an unsaturated carboxylic acids portion of 0.5to 15 percent by weight relative to the polymer are atomized using atomizing agents of 1 to 15 percent by weight of a salt of alkylated diphenyletherdisulphonate acid, caseinate and/or N-alkylosulphosuccinamide or of 1 to 20 percent by weight of a disodium or dipotassium salt or a tetrasodium or tetrapotassium salt of an addition product of N-alkylosulphosuccinamates with maleic acid, mixed with polyvinyl alcohol.

2. Redispersible powders as per claim 1 above, but using 1 to 8 percent by weight of an unsaturated carboxylic acid with one or two carboxylic acid groups.

3. Redispersible powders as per claims 1 and 2 above, but using acrylic acid, methacrylic acid, fumaric acid, maleic acid and/or itaconic acid as unsaturated carboxylic acid.

4. Redispersible powders as per claims 1 through 3 above, but using 2 to 10 percent by weight of a salt of alkylated diphenyletherdisulphonate acid, caseinate and/or N-alkylosulphosuccinamide.

5. Redispersible powders as per claims 1 through 3, but using 2 to 10 percent by weight of tetrasodium-N-(1,2-dicarboxylethyl)-N-oleylsulphosuccinamate as tetrasodium salt of an addition product of N-alkylosulphosuccinamates with maleic acid.

6. Redispersible powders as per claims 1 through 3 above, but using 4 to 15 percent by weight of polyvinyl alcohol.
